(19) United States
(12) Patent Application Publication
(10) Pub. No.: US 2010/0088125 A1
(43) Pub. Date: Apr. 8, 2010

(54) System and Method for Automation and Management of Insurance Claims Processing and Post Placement Transactions

(76) Inventors: David A. VAUGHAN, Bristol (GB); Clifford H. Chapman, Essex (GB); Timothy D. Page, Brighton (GB)

Correspondence Address: Dewey & LeBoeuf LLP, 1101 New York Avenue, NW, Washington, DC, 20005, US

(21) Appl. No.: 12/571,699

(22) Filed: Oct. 1, 2009

Related U.S. Application Data
(60) Provisional application No. 61/102,526, filed on Oct. 3, 2008.

(51) Int. Cl. G06Q 40/00; G06Q 10/00; G06F 17/30; G06F 15/16

(52) U.S. Cl. 705/4; 707/792; 709/217; 707/E17.044

(57) ABSTRACT

A system and method is provided to, for example, manage the process of settling an insurance transaction over a computer network. The management environment is designed to promote collaboration between parties involved in an insurance transaction settlement process by use of defined workflows, digital storage of policy of claim data, and allowing parties to view data and interoperably communicate and transact through the management environment. The management environment serves to improve communication between the parties involved in the insurance transaction settlement process and to reduce costs.

### CROSS-REFERENCE TO RELATED APPLICATIONS

This application is related to and claims the benefit under 35 U.S.C. §119 of U.S. Provisional Application No. 60/102,526, filed Oct. 3, 2008, which is incorporated in its entirety herein by reference.

### FIELD OF THE INVENTION

The field of this invention relates to systems of insurance and reinsurance, and more specifically to a method and system for automating and managing brokered insurance claims over a computer network, including post placement transactions and other similar and/or related transactions.

### BACKGROUND

Many business processes involve the interaction between a customer's requests and the operation of the business. This simple interaction is typically the first instance of inefficiency and source of errors between what a customer wants and what a business ultimately provides. Thus, any means that would improve the accuracy and efficiency of communication in the customer-to-business interaction would decrease costs and decrease errors.

A common business that handles a large number of customer requests is the insurance industry. Such businesses receive a large number of customer requests and therefore must handle a large number of transactions swiftly and efficiently. However, errors or delays may occur in the interaction between a customer's claim for an incident and the insurance and reinsurance company's ultimate payment to settle the claim. Thus, insurance companies incur high expenses related to the costs of overhead when each customer claim is individually handled by a broker or other representative of the insurance company before any payment is made to the customer. Similarly, other post-placement transactions used to reinstate and adjust the status of reinsurance contracts are similarly slow and expensive due, for example, to the role of the Broker in processing them

It is a common problem in the prior art that the role of a broker is too prominent in insurance transactions, particularly industrial, commercial, reinsurance business, and legacy business covering injury or harm taking a long time to become known relative to the coverage period also known as “long tail.” FIG. 4, by way of example, provides a prototypical insurance transaction known in the prior art involving such transactions in the London Insurance Market, where risks are usually syndicated and claims need to be brokered. In the prior art, a broker must typically be involved at multiple stages of the insurance claim settlement and reinstatement transactions, including a responsibility for advising the market or insurers of the claim and separately waiting until a later time to take the settlement of the claim. These stages include, processing the initial reporting (advice) of a claim by the insured 505, optionally sending the claim to a market system such Electronic Claim File (ECF) 515, sending the claim file to other market systems such as Claims Loss Advice and Settlement System (CLASS) 525, 535, syndicating the documentation and handling comments from insurers 560, facilitating payment of the claim and reinstatement where the policy is in need of reinstatement 580, and receiving and forwarding monies paid on the transactions 590. This level of involvement of the broker may result in unnecessary expense, delay, and error in the insurance settlement process. Similarly, FIG. 5, by way of example, provides another prototypical insurance transaction known in the prior art involving such transactions in the London Insurance Market further showing the involvement of the insured in the transaction. In the prior art, a broker must be in communication with the insured at multiple stages of the transaction. These stages may include receiving the insured's claim advice 601, communicating with the insured to handle comments 602, and transacting with the insured to forward received monies 603. Similarly, this level of interaction between the broker and insured may result in unnecessary expense, delay, and error in the insurance settlement process.

Accordingly, a need exists for an improved method and system for automation and management of insurance settlement to improve and/or streamline transactions between the parties involved and lower administration costs and to potentially give greater control to the Insured.

### SUMMARY OF THE INVENTION

To overcome the limitations of prior insurance claim settlement transactions or similar transactions, it is therefore an object of an embodiment of the present invention to streamline a complex process of settling insurance claims through, for example, a system and method capable of electronically coordinating settlement of an insurance transaction over the Internet or other such computer network. The present invention is, for example, potentially capable of providing, in one or more embodiments, a computer network based insurance transaction system and process that enables the settlement of an insurance transaction that minimizes and optimally eliminates the involvement of a broker. The system and process of the present invention may also be applicable to transactions with attributes that are comparable to insurance transactions. Similarly, in one or more embodiments, the present invention, for example, is capable of providing a reduction or substantial elimination of the involvement of a broker, allowing repatriation of processing to policyholders, and perhaps additionally capable of facilitating direct settlement between counterparties via peer-to-peer processing. The present invention, in one or more embodiments, may also facilitate interoperability between parties interacting in the claim settlement process through use of existing methods of operation such as various market systems such as, for example, London Market Processing systems such as ECF and CLASS. The present invention further may reduce the time required for notification and settlement of claims, and other transactions, increasing transparency by making files accessible to parties over the Internet, and may also reduce costs associated with distributing claim information to parties involved in the settlement process.

In one embodiment there is provided a management environment that may contain a control module directing user interactions, and a database containing documents, data, or other pertinent information to the settlement process. The management environment is capable of managing interacting parties to the settlement process, potentially including brokers, clients, underwriters, reinsurance syndicates, market systems, or other similar claim participants, to final settlement of an insurance or reinsurance claim.

In another embodiment of the present invention, the management environment may contain a database for insurance policy data and a separate database for documents pertinent to the insurance policy, said insurance policy perhaps being useful for the validation of potential insurance transactions that may also be stored in the system.

In another embodiment of the present invention, the management environment may store or otherwise contain workflows that perhaps describe the procedures, processes, or steps required to guide parties interacting with the management environment to a final settlement of an insurance transaction. The management environment may also make use of these workflows to guide interacting parties to settlement of a transaction. Parties interacting with the management environment could perhaps initiate or customize the workflows.

In another embodiment of the present invention, the management environment may contain an access control feature that could manage an interacting party's access or security rights to the management environment and its resources based on credentials supplied by the interacting party. Said credentials may consist of a user name, password, organizational identity, or other information. Parties interacting with the management environment may further customize access or security rights via an access control feature. The interacting party's ability to customize the access control feature may be subject to security rights of the party that may be tracked by the access control feature.

In another embodiment of the present invention, the management environment may contain a messaging feature. The messaging feature may, for example, have the ability to send communications to interacting parties. The messaging system may also have the ability to receive communications from interacting parties. The communications themselves may be configured to interact with an interacting party that is an individual participating in the transaction settlement process or otherwise intended to receive communication regarding the transaction settlement process. The communications may also be configured to interact with an interacting party that perhaps employs a structured communication system or other computerized market system, including, by way of example, the London Insurance Market Bureau. The communications may be used to transmit or receive various information, including, but not limited to, queries generated by interacting parties, responses to queries generated by interacting parties, claim or policy documents to be lodged with interacting parties, claim or policy data to be lodged with interacting parties, instructions to flag or other such signals that may be utilized by third parties employing structured communication systems, or other material.

In another embodiment of the present invention, the management environment may track or store queries generated by interacting parties in varied stages of the transaction settlement process. Queries could be initiated against a particular claim, against a particular policy, or be initiated without a related claim or policy. The queries may be used by the management environment to obtain approval for the insurance claim by resolving discrepancies in the claim, or to refute the validity of the claim. By way of example, if the insurer as an interacting party generates a query for an outstanding claim, the messaging feature may send a query regarding an outstanding claim to the insured or broker as interacting parties. The messaging feature could also be configured to receive responses to the query from an interacting party. The sending and receiving of queries and responses may allow the interacting parties to advance the approval of the transaction through communication, perhaps leading to quicker settlement of the transaction.

In another embodiment of the present invention, the management environment may utilize industry standards that could facilitate interoperability. Such standards could, for example, include Association for Cooperative Operations Research and Development (ACORD) and London Insurance Market (LIM) standards. Such standards may be partially or fully adhered to when describing the data, format of documents, types of documents, communications, or other information stored or managed by the management environment.

The invention may reduce the number of human interactions that occur in order to process an insurance claim to settlement or other similar transactions by bringing interacting parties together on a digital platform that streamlines the settlement of insurance transactions. The management environment may have one or more databases that contain documents, data, and other pertinent information to the insurance policy or claim. By way of example, it is through interaction with the management environment that the role of an insurance broker may be rendered optional to the transaction settlement process that may result in a cost savings to the insurer or other interacting party. The invention may also present to interacting parties a level of transparency to the transaction settlement process that does not exist in the prior art. The invention may further improve service levels to the interacting party filing the transaction through increased speed of processing and potential reduction of human error.

As further clarification of certain embodiments introduced above and described below, the invention may, for example, allow users, to connect their potentially disparate systems to the various services envisioned among the present invention. Such connections may allow these users to, for example, have a single and/or consistent view of the relationship(s) between their organization(s) and other participating organizations for one, any, or all claims or transactions and/or post placement activity. Further, one or more embodiments of the systems contemplated by the present invention may be adapted to be capable of providing downloads of information to its users, thereby allowing them to reflect, for example, the current transactional agreement status back within their own systems.

One embodiment of the present invention, as described above, includes a system that may be adapted to create a credit control environment for its users which may, in addition to providing overall information relating to the status of a book, may further alert internal users to the agreement of certain transactions and may further facilitate tracking and reconciling funds.

Further, the present invention in certain embodiments may, by incorporating certain validation rules, provide the ability to initiate downstream processing of a myriad of different transactions. For example, an embodiment of the present invention is contemplated wherein reinsurers that choose to use one or more systems of the present invention to standardize the presentation of claims information received by them may be provided the ability to automatically agree to certain transactions based upon certain preprogrammed values held by or otherwise within the system and may further both send back funds and initiate a payment process without the necessity of human intervention.

Various aspects and embodiments of the present invention, as described in more detail and by example below, address some of the shortfalls of the background technology and emerging needs in the relevant industries.

### BRIEF DESCRIPTION OF THE DRAWINGS

The accompanying drawings, which are included to provide a further understanding of the invention and are incorporated in and constitute a part of this specification, illustrate exemplary embodiments of the invention that together with the description serve to explain the various principles of the invention. In the drawings:

FIG. 1 shows one such communication process flow representing an embodiment of the present invention.

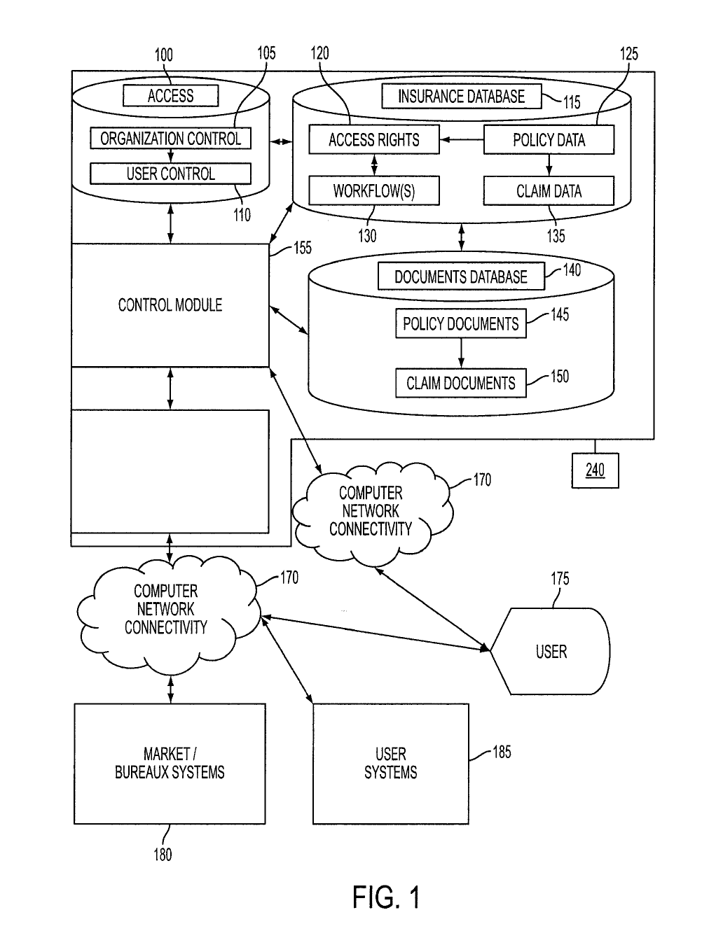

FIG. 2 shows one such diagram of party interaction representing an embodiment of the present invention.

FIG. 3 provides a process description chart of settling a claim in an embodiment of the present invention.

FIG. 4 provides a process description chart of settling a claim in a prototypical example of the prior art.

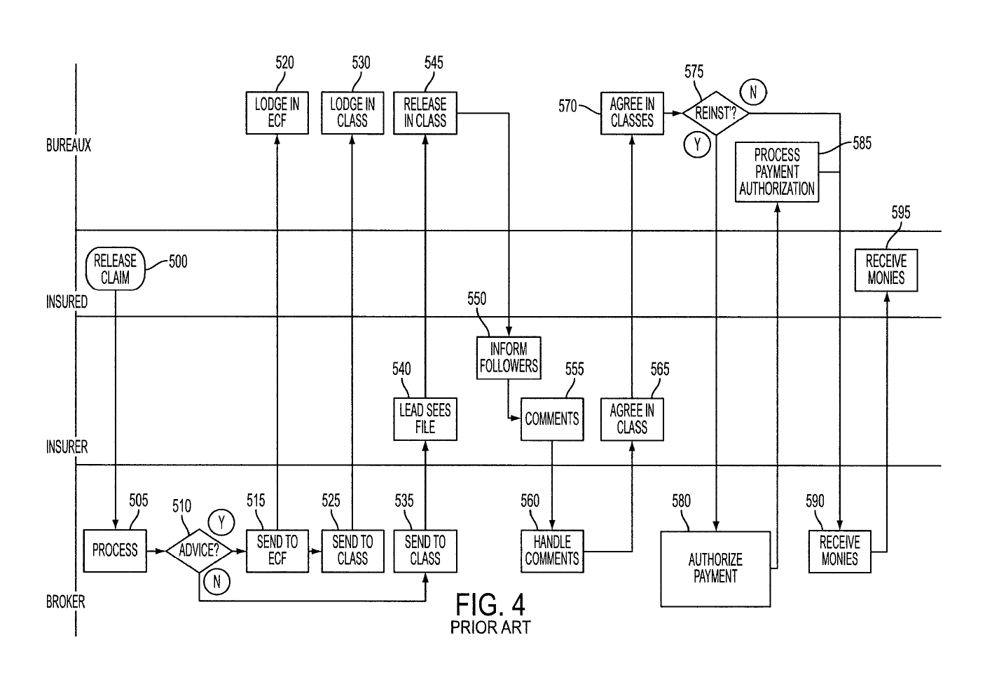

FIG. 5 provides an additional description chart of settling a claim in a prototypical example of the prior art.

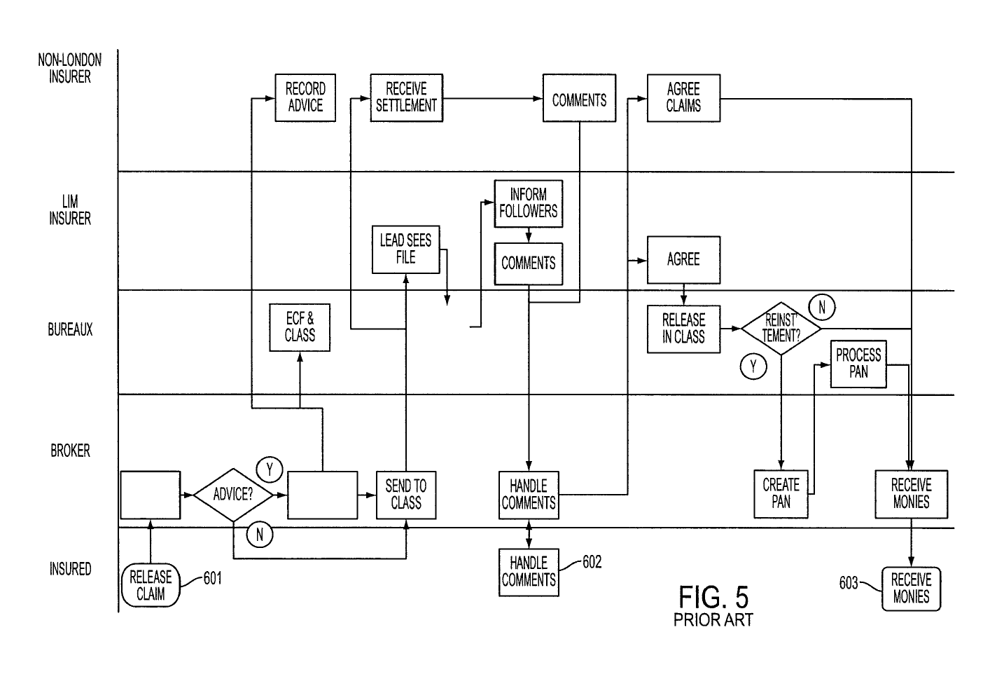

FIG. 6 provides a process description chart of settling a claim in an embodiment of the present invention.

FIG. 7 provides a diagram of party interaction related to movements managed in an embodiment of the present invention.

FIG. 8 provides an illustrative point of entry for users to the management environment in one embodiment of the present invention.

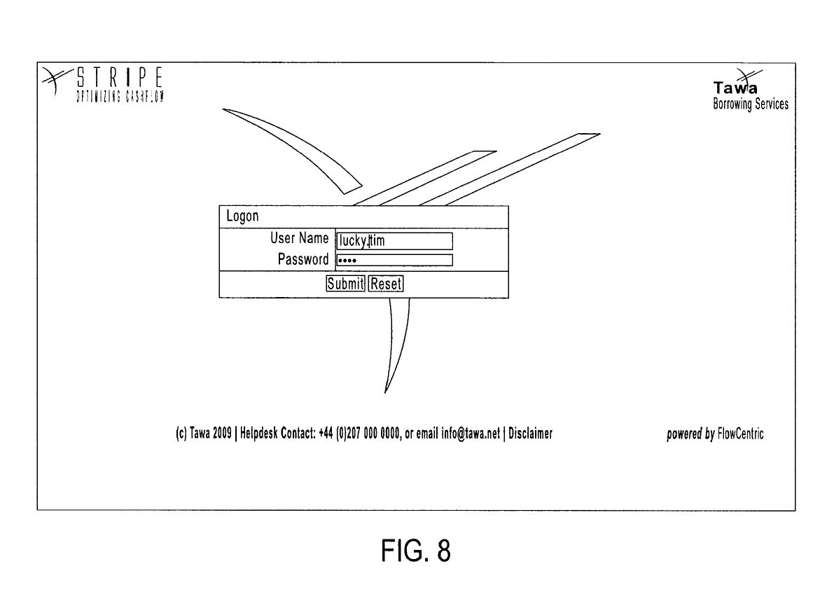

FIG. 9 provides an illustrative user interface for users to view messages in the management environment associated with the user in one embodiment of the present invention.

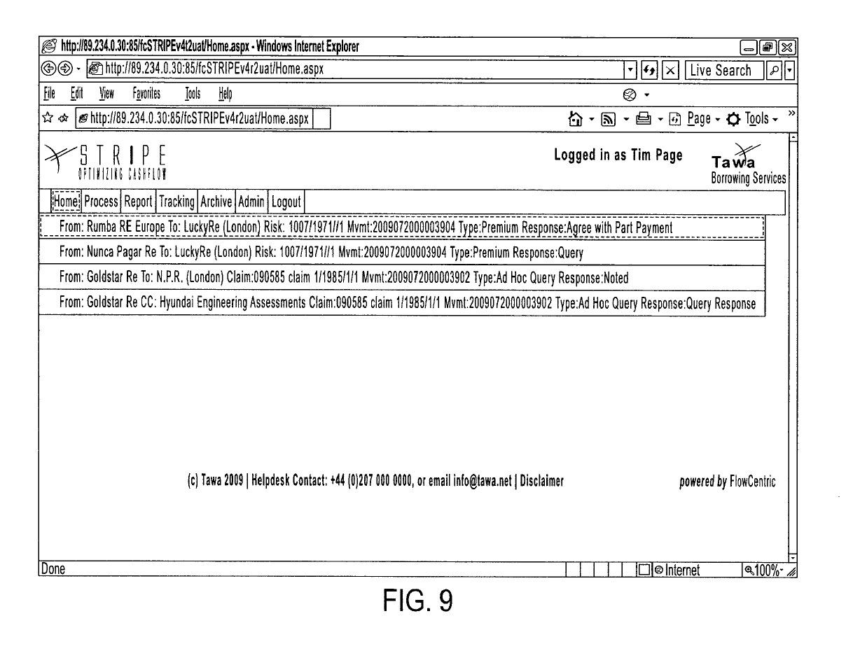

FIG. 10 provides an illustrative user interface for a user to view a single message in the management environment and data associated with the message in one embodiment of the present invention.

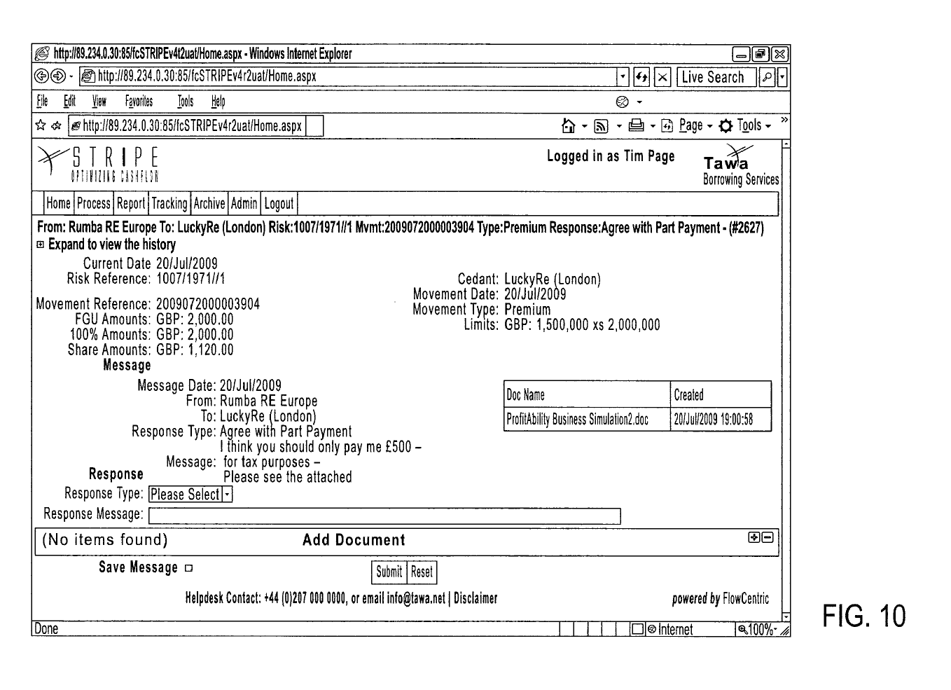

FIG. 11 provides an illustrative user interface for a user to respond to a message in the management environment and to provide documents and data associated with the responsive message in one embodiment of the present invention.

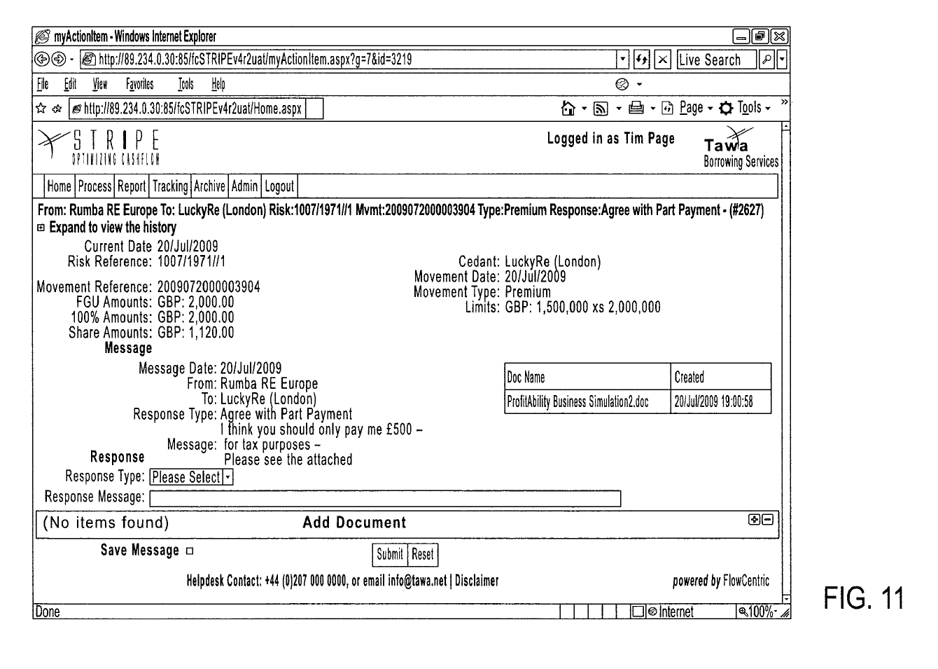

FIG. 12 provides another illustrative user interface for a management environment display showing action items associated with the user in one embodiment of the present invention.

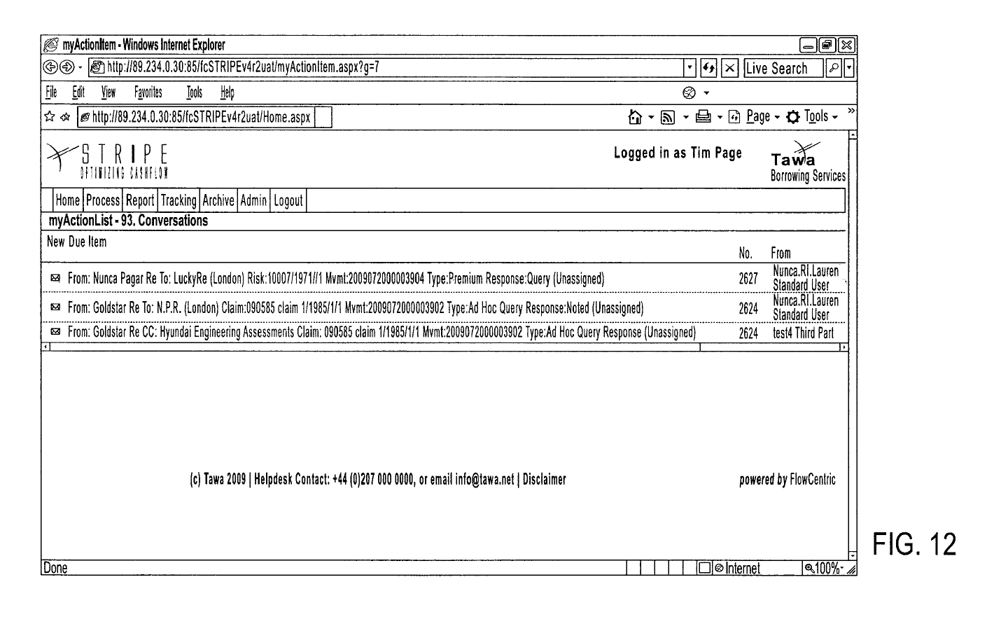

FIG. 13 provides an illustrative user interface for a user to access risks associated with the user in one embodiment of the present invention.

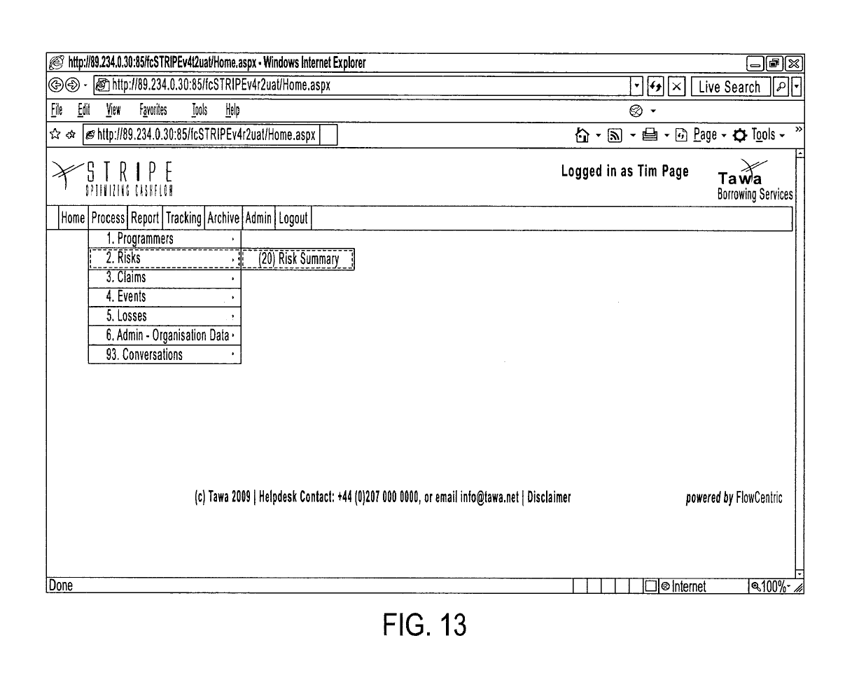

FIG. 14 provides an illustrative user interface for a user to search for risks on the management environment associated with the user in one embodiment of the present invention.

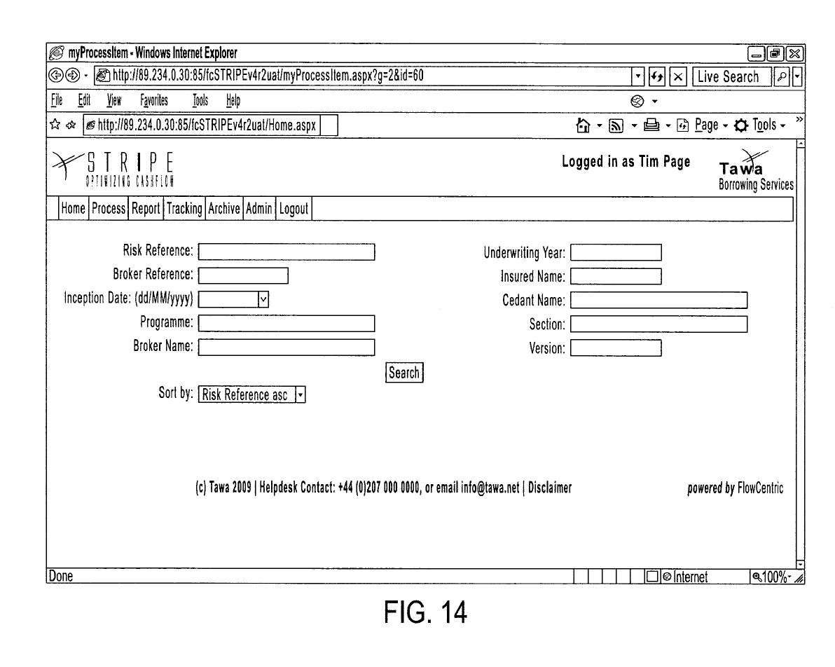

FIG. 15 provides an illustrative user interface for a user to view risks that are associated with the user in one embodiment of the present invention.

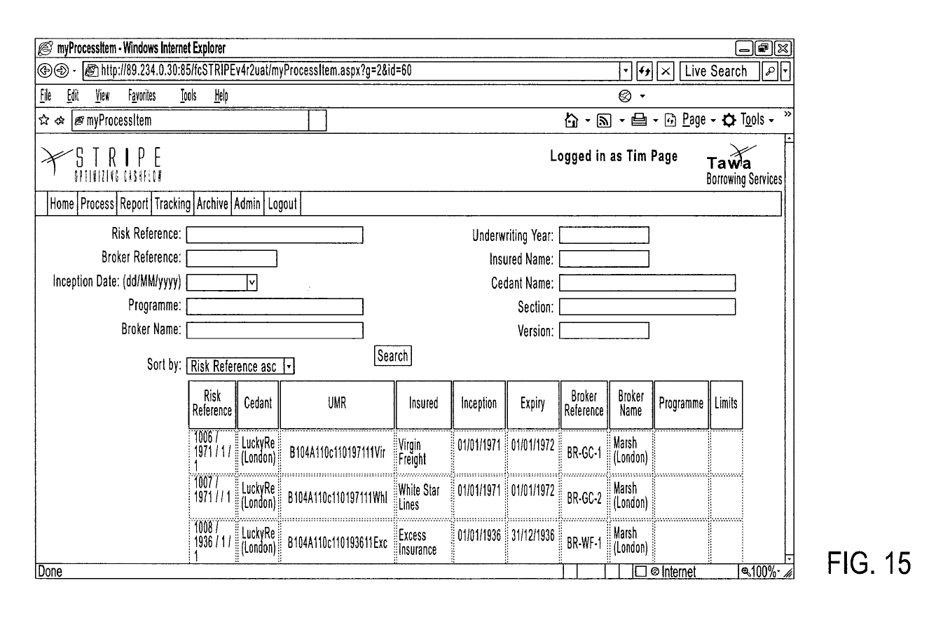

FIG. 16 provides an illustrative user interface for a user to view data and information related to a risk stored on the management environment in one embodiment of the present invention.

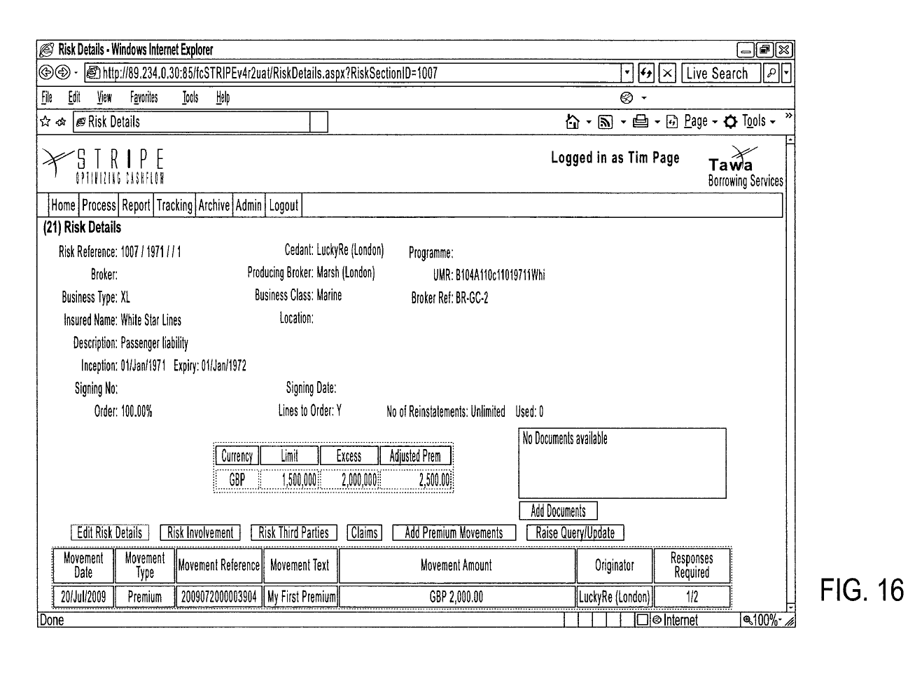

FIG. 17 provides an illustrative user interface for a user to view reinsurers associated with the risk and related data, including market apportionment in one embodiment of the present invention.

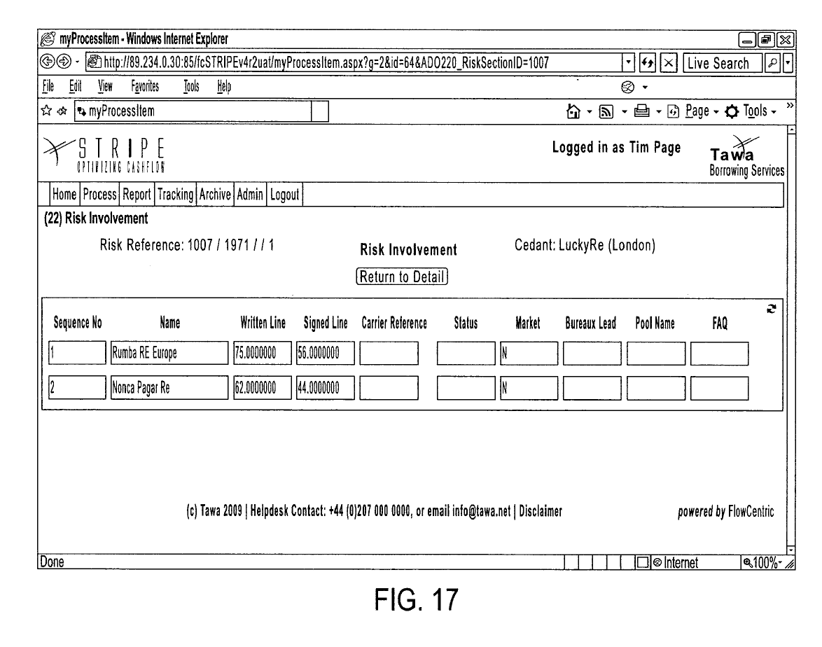

FIG. 18 provides an illustrative user interface for a user to view claims associated with the risk and related data in one embodiment of the present invention.

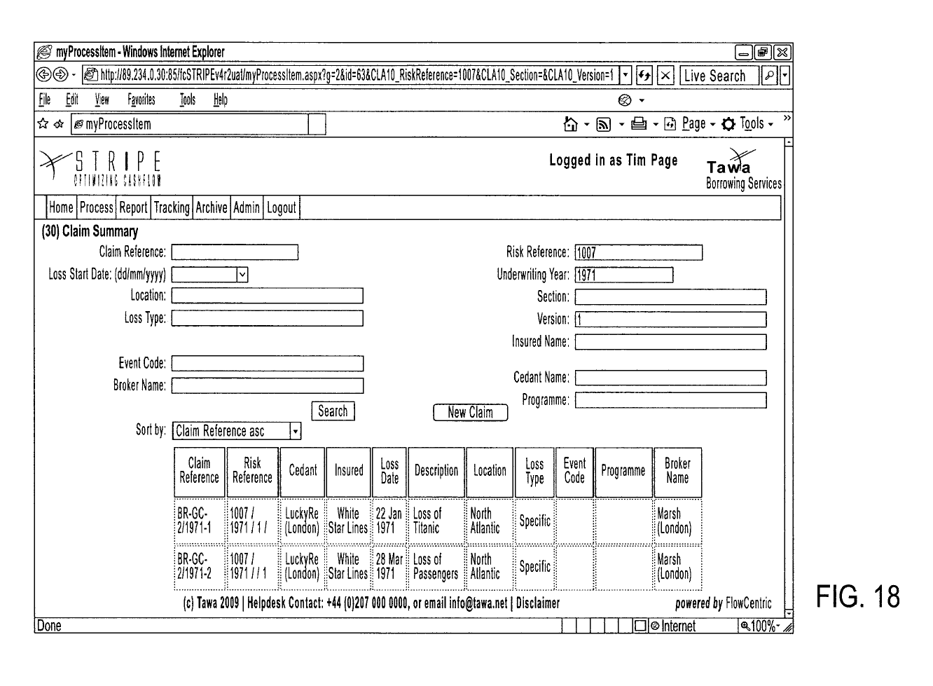

FIG. 19 provides an illustrative user interface for a user to view data related to a particular claim in one embodiment of the present invention.

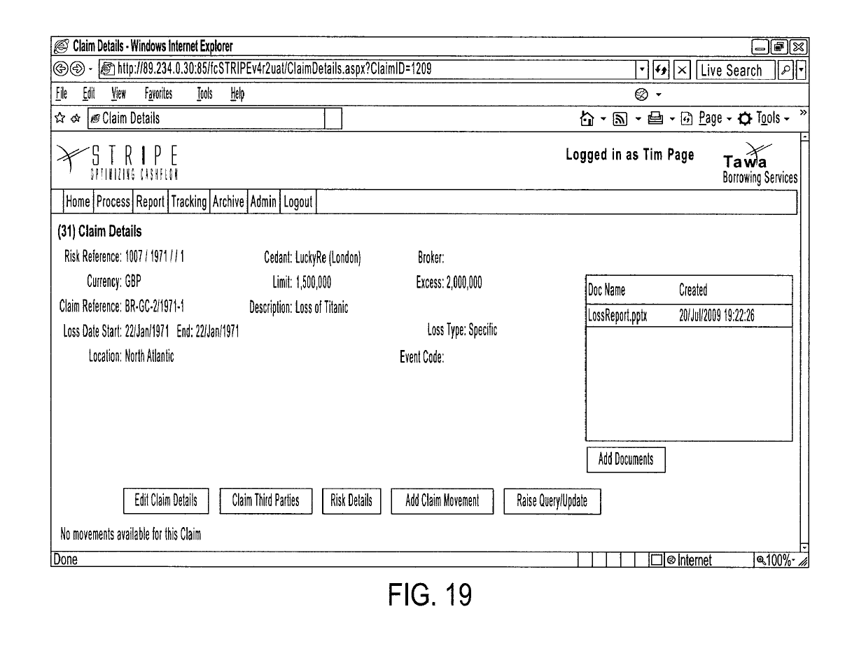

FIG. 20 provides an illustrative user interface for a user to initiate a movement in one embodiment of the present invention.

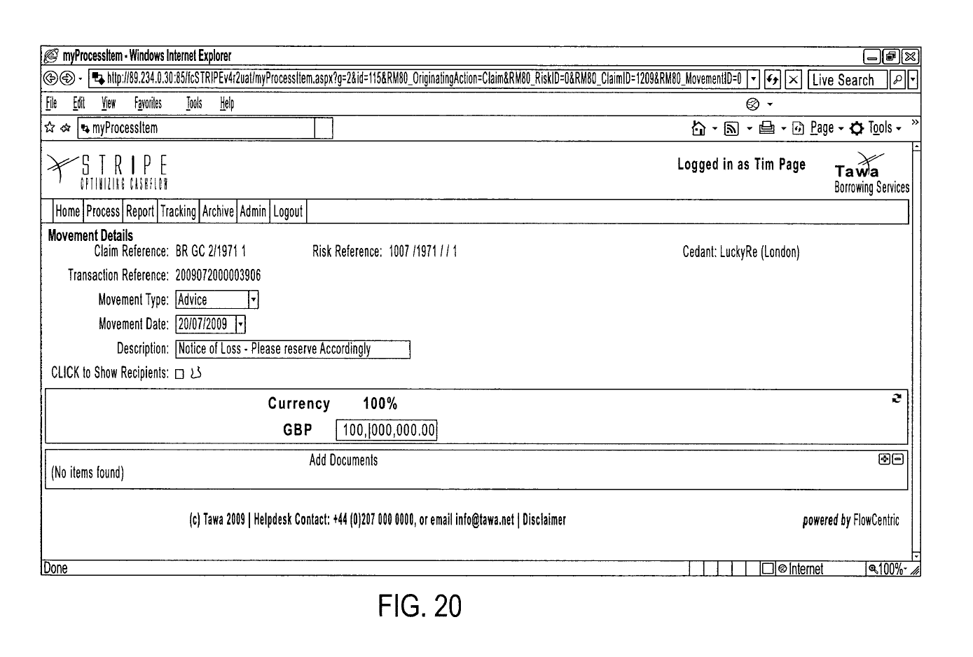

FIG. 21 provides an illustrative user interface for a user to communicate the movant to other parties in the settlement process in one embodiment of the present invention.

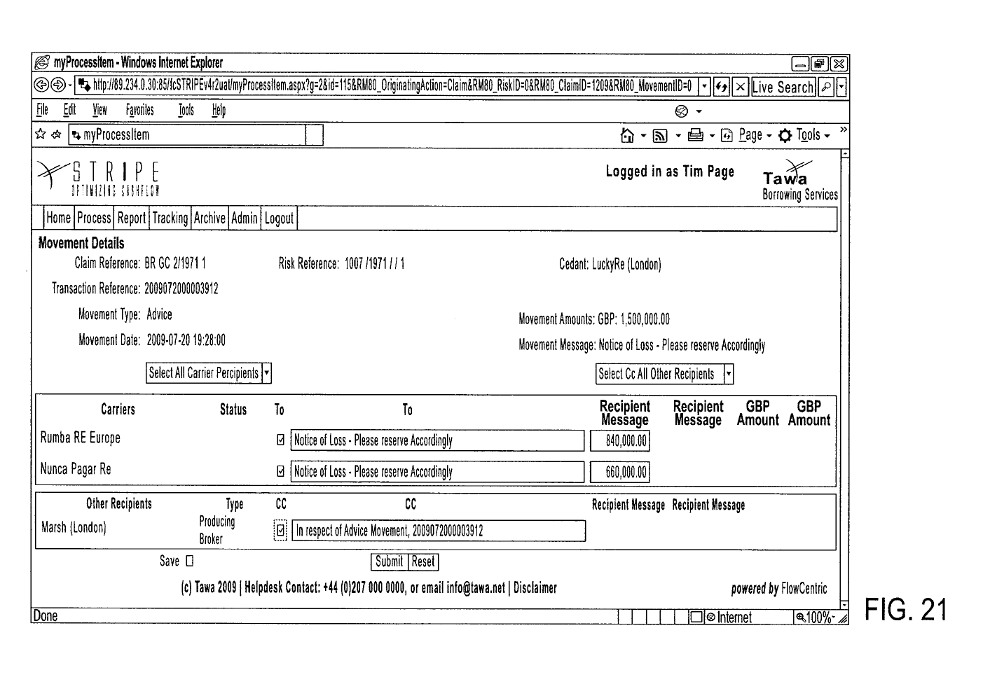

### DETAILED DESCRIPTION

The present invention will now be described more fully with reference to the accompanying drawings, in which certain preferred embodiments of the invention are shown. The invention may, however, be embodied in many different forms and should not be construed as being limited to the embodiments set forth herein. Rather, the embodiments are provided so that this disclosure will be thorough and complete, and will fully convey the concept of the invention to those skilled in the art.

It is to be understood that the present invention is not limited to the particular systems, methodology, uses, and applications described herein, as these may vary. For example, it is understood that the present invention is not limited to insurance transactions and may also apply to reinsurance, risk management, or other insurance transactions. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, systems, and techniques are described, although any methods, systems, or techniques similar or equivalent to those described herein may be used in the practice or testing of the present invention. Methods and systems described herein are to be understood also to refer to functional equivalents of such methods or systems.

All patents and other publications identified are incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason.

Broadly described, the present invention improves, for example, insurance transaction settlement processes by creating an ecosystem that stores, maintains, and may allow, for example, management of any of communications, policy documents, policy data, claim documents, claim data, transaction documents, transaction data, workflows, access rights, and other relevant data. Furthermore, the present invention may streamline, for example, the insurance transaction settlement process by management of any of the aforementioned information. Due to the reduced need for a broker and the improved management of data, such transaction administration may be conducted at significant cost savings, and in shorter timescales than industry-standard procedures. Through the system, service may be improved to the insured or other parties interacting during the settlement of an insurance transaction by increased speed and accuracy of the transaction settlement process. These improvements are described by example in more detail below.

In one embodiment, the system may include a management environment 240 which comprises a computer, typically having a CPU, a connection to one or more databases, and a communications link to the Internet. The management environment can store and maintain any of various data related to closing, including but not limited to: process workflow information 130, access rights information 120, policy data 125, claim data 135, policy documents 145, claim documents 150, queries, communications, assignment information, directories, requests, and other data and information. The management environment may include multiple databases containing sets of information. For example, the management environment may contain a documents database 140 containing documents relating to the insurance policy 125 or documents relating to an insurance claim 135. The management environment may also contain an insurance database 115 containing data relating to policies 125, data relating to transactions 135, process workflows 130, and access rights information 120. The management environment may also contain a database for storing access control information, including, by way of example, user control information and organizational control information. The management environment may allow interacting parties, perhaps comprised of users, access to the system via computer network connectivity 170 to interact with control module 155 that may orchestrate insurance transaction settlement workflow. Users may carry out such interaction via an input device, such as a personal computer with network connectivity 170. Interactivity of the parties with the control module of the management environment may be regulated by an access control feature described in further detail below. Communications or other interactions occurring over the computer network connectivity may be encrypted or otherwise secured using standard security measures such as Secure Socket Layer (SSL) technology or other communication security measures.

The system could also include, by way of example, an access control feature perhaps capable of tracking various organizations, users, access rights, credentials, or other permissions. The access control feature may consist of a control module 155 and an access control database 100 for storing information relating to access. The control module may be capable of communicating with interacting parties via computer network connectivity 170 by way of a customary web service to Internet browsers, and may be separately capable of communicating with the access control database 100.

The access control feature could provide for management of organizational control 105 and user control 110 data. An interacting party, which could be any of various users 175, user systems 185, or market systems 180, could manipulate the access control feature to allow or disallow or otherwise regulate access to information and behaviors of the management environment at the user control or organizational control level. For example, an interacting party with sufficient access rights, as perhaps regulated by the access control feature, could create, modify, delete, or otherwise manipulate organizational control data, including but not limited to information describing an organization and its attendant access rights. This could be used to create, delete, or otherwise manipulate organization objects that may describe organizations, such as, by way of example, a counterparty to an insurance policy. This may also result in the creation, deletion, or other manipulation of an access profile for the organization object that could describe the access rights that may be used to regulate access to features of the management environment of an interacting party associated with the organization object. Access profiles could also be pre-defined sets of access rights, or “roles,” that could be applied to the organizational control level. Similarly, an interacting party with sufficient access rights, as perhaps regulated by the access control feature, may create, modify, delete, or otherwise manipulate user control data, including but not limited to information describing a user and its attendant access rights. This may further be used to create, delete, or otherwise manipulate user objects. This may also result in the creation, deletion, or other manipulation of an access profile for the user object that could describe the access rights that may be used to regulate the access to features of the management environment of an interacting party that may be associated with the user object. Access profiles may further be pre-defined sets of access rights, or “roles,” that could be applied to the user control level. User objects at the user control level 110 may also be associated with organization objects at the organizational control level 105 so as to inherit the associated access rights or roles of the desired organization object.

The system also may include the ability for interacting parties to create, delete, or modify certain preferences for their profile as stored an associated user object via user display interfaces and subject to their access profile. Such preferences may include default formatting of communications with the management environment.

The system also may include the ability for the parties interacting with the management environment via user display interfaces to view and manage various organizational data subject to their access profile. Such organizational data may include workload, perhaps described as the number of workflows, tasks, or other such assignments associated with a particular user as embodied by a user object. Such organizational data may further include backlog, perhaps described as the amount of workflows, tasks, or other such assignments tending to accumulate perhaps resulting in delay, or the amount of such assignments in excess of typical workloads. Such organizational data may further include management information, perhaps described as the number of outstanding claims, money outstanding, progress of claims, or other such data generated by the management environment tending to assist managers of interacting parties in processing insurance transactions. The management environment, by way of the control module 155 communicating with interacting parties over computer network connectivity 170 may allow for the manipulation of users as embodied by user objects to active workflows, tasks, or other such assignments in light of a user's workload and backlog, so as to optimize the distribution of work amongst users in the management environment.

The system may also include individual workflow management, perhaps comprised of user display screens implemented by the control module 155, allowing users as embodied by user objects to view outstanding work associated with the user, outstanding items for the organization associated to the user, incoming messages to the user, outgoing messages from the user, items with counterparties, and other information tending to advance the settlement of insurance transactions by apprising the user of their responsibilities in the insurance settlement transaction. The user may be provided access to this information subject to their access profile. Optionally, this information may be communicated to the interacting parties by way of the messaging module further including, for example, digital communications such as e-mail.

The system may also include management of a policy file that may include policy data 125 contained in an insurance database 115. Users embodied by user objects may have the ability to create, delete, or modify the policy file, such modifications potentially including permissions associated to the policy file for use with an access control feature, counterparties, data regarding the insurance policy that is standard to the industry, and other policy information. The inclusion of the counterparty information in the policy file may be useful for identifying the market system that may drive processing of the transaction outside of the management environment. It is understood that messaging requirements for the messaging module may vary based on the market system, and thus tracking the market system may be important to any attempt to obtain messaging interoperability between the interacting parties. The system may also allow the counterparty, as an interacting party, to add details referencing their identity to these records, such as a reference number. The policy file may be viewed by any interacting party subject to their access profile.

The system may also include management of policy file detail, perhaps comprised of policy documents 145 contained in a documents database 140. Users embodied by user objects may have the ability to create, delete, or modify the policy file, such modifications perhaps including uploading or removing policy file pages in digital format. The pages of the policy file may be added as images, such as JPEG, TIFF, or other formats. The policy file may have permissions associated with its contents for use with the access control feature. The permissions may also be applied to each individual page of the policy file so that the access control feature could perhaps limit user access on an individual-page basis. The policy file detail may be viewed by any interacting party subject to their access profile.

The system may also include management of a claim file, perhaps comprised of claim data 135 contained in an insurance database 115. Users embodied by user objects may have the ability to create or modify the claim file, such modifications perhaps including permissions associated to the claim file for use with the access control feature, counterparties, data regarding the insurance transaction that is standard to the industry, and other transaction information. The system may also allow the counterparty, as an interacting party, to add details referencing their identity to these records, such as a reference number. The claim file may further be viewed by any interacting party subject to their access profile. Upon creation, modification, or deletion of a claim file, communications may be created and transmitted by the messaging module 160 to cause the changes to be reflected on a market system 180, such as Bureaux, that may or may not be involved in the insurance transaction. By way of example, creations or other changes to the claim file could be used to maintain an Electronic Claim File (ECF) as shown by step 340 if a Bureaux system were involved in the claim settlement process.

The system may also include the management of claim file details that may, for example, include claim documents 150 contained in a documents database 140. Users embodied by user objects may further have the ability to create, delete, or modify the claim file, such modifications potentially including uploading or removing claim file pages in digital format. The pages of the claim file may be added as images, such as JPEG, TIFF, or other formats. The claim file further may have permissions associated with its contents for use with the access control feature. The permissions may also be applied to each individual page of the claim file so that the access control feature may limit user access on an individual-page basis. The claim file detail may, for example, be viewed by any interacting party subject to their access profile. Upon creation, modification, or deletion of a claim file detail, communications may be created and transmitted by the messaging module 160 to cause the changes to be reflected on a market system 180 if such a system were involved in the claim settlement process.

The system may also be configured so the management environment 240 may raise queries of any party interacting with the management environment. Such queries may be initiated by the user or otherwise generated to request a response from the party to which the query is directed. The queries may be communicated to the interacting parties via computer network connectivity 170 by way of the messaging module 160. The communications may, for example, take the form of emails. Furthermore, the management environment may be configured to store the queries within the management environment 240 and provide the queries to users through display interfaces accessible via interaction with the control module 155. Similarly, users receiving queries may communicate responses to the management environment 240 via computer network connectivity 170, or perhaps via the control module 155 accessed over the computer network connectivity 170.

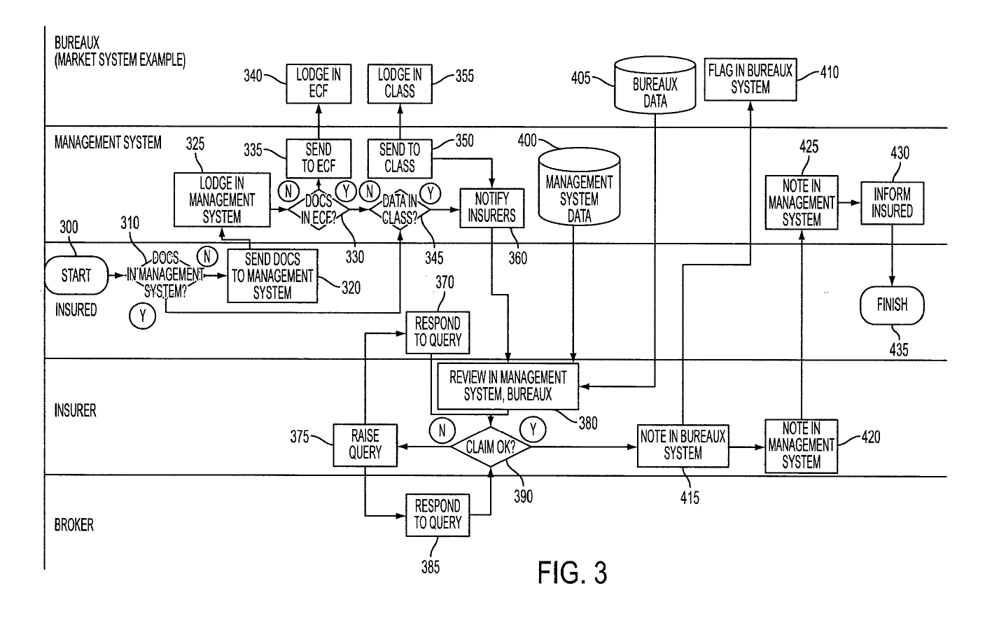

The system may also be configured so the management environment, which may contain control module 155, can utilize workflows 130 to guide the insurance transaction settlement process to its conclusion. In one such embodiment of the present invention, the user may interact with the control module to initiate a workflow which may, by way of example, correspond to the initiation of an insurance transaction 300 as depicted in FIG. 3. The control module will assess whether documents necessary to the assessment of a filed claim are present 310 in the management environment. If the documents are present, the control module may progress to assessing whether the data has been entered in a market system such as Claims Loss Advice and Settlement System (CLASS). If the documents are not present, the user is instructed though communication with the control module, to upload necessary documents to the management environment as shown 310. Once uploaded, the documents may be lodged in the management environment 325, perhaps in the document database or insurance database or such other database as configured with the system. The control module, in continuing implementation of the exemplar workflow, may check to see if an Electronic Claim File (ECF) has been created in any market system that may be associated with the transaction 330. By way of the messaging module, the management environment may be able to send the necessary information to the market system to create an ECF 335. The messaging module may be able to format communication perhaps according to the associated market information associated with the claim file. It is understood that a standard market system, such as Bureaux, may further accept this exemplary information and lodge it in ECF 340 as a result of a messaging module 160 communication via computer network connectivity 170.

In an exemplary workflow, progress may continue to be made with reference step 345 whether or not documents are initially uploaded to the management environment in step 310. The control module will then assess whether the claim information has been uploaded in a market system such as Claims Loss Advice and Settlement System (CLASS) 345. If the control module determines that the claim information has not been uploaded, the control module 155, by way of the messaging module 160 may send a message to the CLASS system via computer network connectivity 170. It is understood that a standard market system, such as Bureaux, may, for example, accept this information and lodge it in CLASS 355 by way of a communication from messaging module 160 over computer network connectivity 170. After sending a communication to CLASS 350 or determining via communication CLASS that the information is already contained on such a system, the management environment may notify an interacting party, perhaps an insurer, that the claim has been filed by the user initiating the claim.

Upon notice to the user, the management environment, by way of the control module, may manage the review of the claim. The transaction information may be available to interacting parties' users through the control module subject to their access profile, allowing the user or users to review the transaction 380 and determine whether the transaction is acceptable 390. If the user determines that the transaction is unacceptable as filed, the management environment by way of the control module, allows the user to generate queries 375 to other users associated with the insurance transaction. Said other users may, by way of example, include insured persons or brokers. The management environment, by way of the control module, may allow these other users to take actions to overcome the query through the control module 155 and respond to the query, 370, 385, which may position the claim for further review before the user that initiated the query. The initiating user may continue to initiate queries 375 or may approve the transaction. Upon approval, the control module, by way of the messaging module, may send a communication to any market system that may be associated with the transaction to note the acceptance in that system 415. It is understood that standard market systems, such as Bureaux, may flag the transaction acceptance in their systems 410. The acceptance of the transaction may be further noted in the management environment 420, 425. The management environment may then send a communication to the insured notifying them of the acceptance of the transaction 430, thereby reaching the conclusion of the exemplar workflow 435.

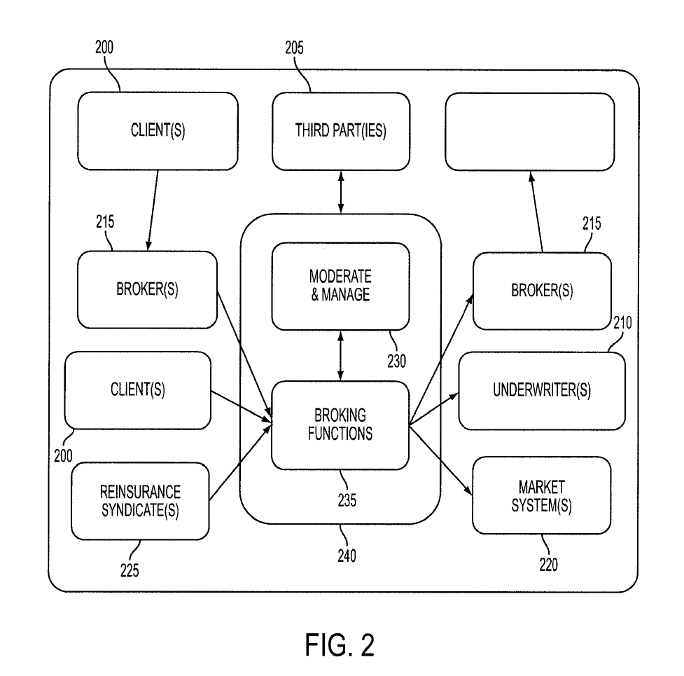

As a result of the automation and management of communications and workflows, the involvement of broker 215, as depicted in FIG. 2, may become minimized or eliminated. In sum, the invention in one or more embodiments may combine the resources of various parties involved in an insurance transaction settlement process and the speed of computer networks with additional knowledge of the workflow processes involved in settling insurance transactions in order to deliver a method and system capable of automating and managing, for example, insurance transaction processing over a computer network such as the Internet. The invention may, for example, allow policy holders or clients 200 to interact directly with insurers without any direct interaction with the broker 215 who placed or currently services the insurance business.

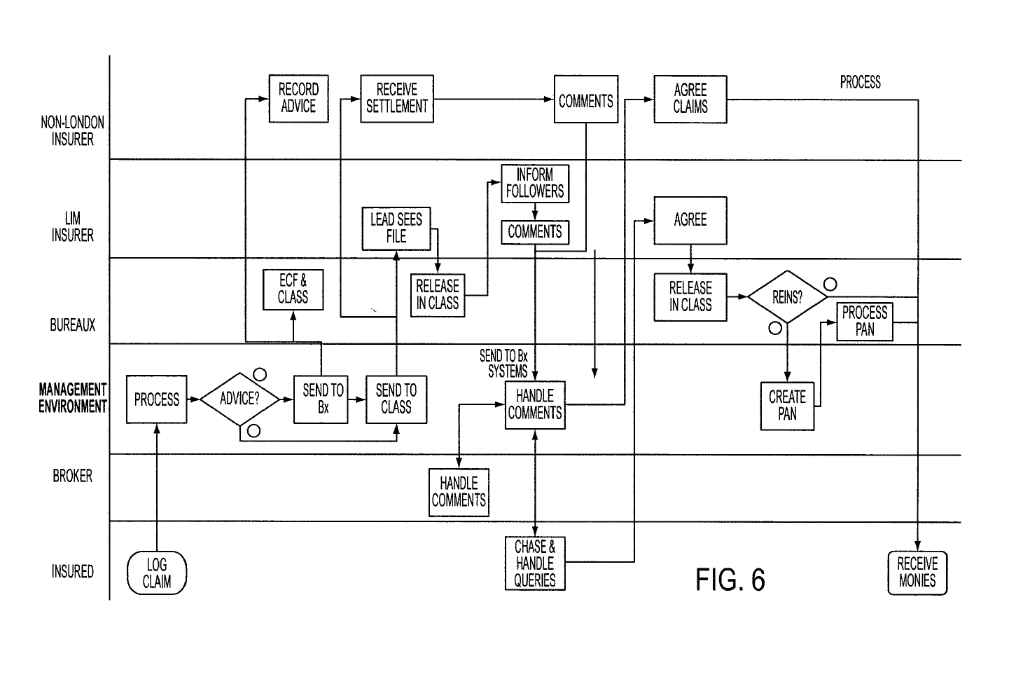

In another embodiment of the present invention, the user may interact with the control module to initiate a workflow which may, by way of example, correspond to the initiation of an insurance claim 701 on the London Insurance Market (LIM) as depicted in FIG. 6. The control module of the management environment may process the transaction 702 and determine whether to advise [more description from functional spec, stepthrough workflow] 703.

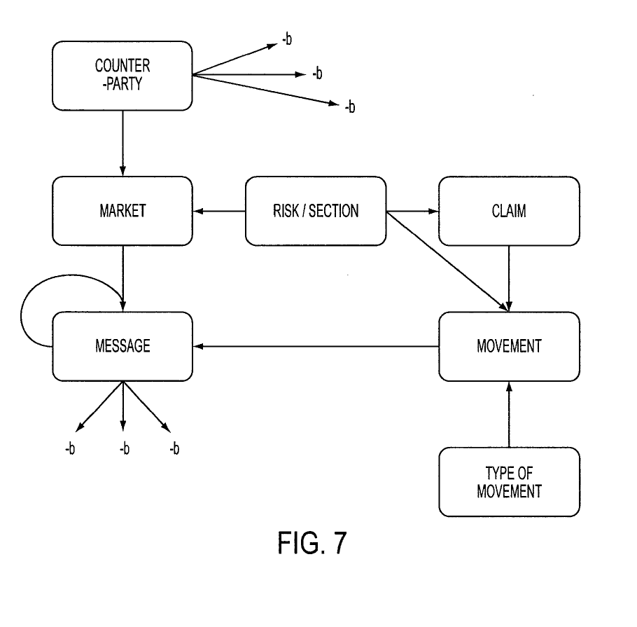

As further shown in FIG. 7, the management environment may further facilitate communication between parties 800 involved in certain transaction settlement processes. The management environment may hold risk data, possibly uploaded from the broker's records. Files related to the risk may be held in the management environment. Such files may include slips, wordings, and endorsements. The market system 801 for the risk 802 can be used to establish access rights to data and documents for various uses, including brokers, clients, underwriters and agents 800. Furthermore, counterparties to the risk 803 can manage, via the management environment, which users have access to which files. Establishment of access rights allows the management system to provide access to data and documents to only those users who are properly entitled. Each risk stored in the management environment may have claims 804 and movements 805 associated therewith. Movements 805 represent any type of transaction related to a risk or claim 806. Such movements may include, but are not limited to, reinstatements, advices, settlements, and treaty statements. Movements can be stored and managed on the management environment and may contain, among other data, financial values, the type of transaction, and any documents associated with the movement. Furthermore, the management environment may provide the ability to message parties in furtherance of transaction settlement via a messaging module 807. Messages allow counterparties to have private or public discussions relating to a movement 805 and may allow the counterparties to answer queries, add additional information regarding the movement, include additional parties, or call for broker assistance if necessary. Messages themselves support queries and agreements, including attached documents and may optionally be stored into perpetuity.

As explained above, certain embodiments of the present invention, as for example shown in FIG. 7, may enable the users of a system of this invention to raise multiple transactions against a risk and/or claim to facilitate one or more activities such as post-placement transaction activities. This capability may include, for example, the process of agreeing to and/or settling premiums adjustments, refunds, and/or reinstatements as well as treaty statements against risks in the system and/or agreeing to and/or settling claims advices, precautionary advices, settlement(s), refunds as well as or including treaty cash claims against risks in the system. These processes may further be backed-up by one or more embodiments of the system supporting negotiation and document or file sharing between parties to one or more of the transactions contemplated.

As further explained above and throughout the specification, one or more parties may be able to use an embodiment of the system to include third parties to a negotiation or other transaction and/or file sharing process and may further involve that third party in, for example, risks or claims as, for example, a third party.

As a further clarification of the discussions throughout the specification, the present invention may include as one or more embodiments a system used by brokers as, for example, a cost-effective means for distributing or sharing information and performing one or more, any or all post-placement transactions on behalf of a client or client base. These brokers may further opt to devolve management of portions of a portfolio to another party as, for example, when that party is desirous of or prepared to take over those functions from a broker or other similarly situated party or agent.

The embodiments described above are exemplary only. One skilled in the art may recognize variations from the embodiments specifically described here, which are intended to be within the scope of this disclosure. As such, the invention is limited only by the following claims. Thus, it is intended that the present invention cover the modifications of this invention provided they come within the scope of the appended claims and their equivalents. Further, specific explanations or theories regarding the formation or performance of electrochemical devices according to the present invention are presented for explanation only and are not to be considered limiting with respect to the scope of the present disclosure or the claims.

What is claimed is:

1. A method for electronically managing and automating an insurance transaction settlement process, said method comprising the steps of:
receiving information associated with the insurance transaction settlement process at a management environment via an input device communicating with the management environment over computer network connectivity; and
supplying information associated with the insurance transaction settlement process to the input device via the management environment in communication with the input device over computer network connectivity.

2. A method according to claim 1, further comprising the step of receiving information describing a party involved in the insurance settlement process at a management environment via the input device communicating with the management environment over computer network connectivity.

3. A method according to claim 2, wherein information describing a party comprises one or more of: organization information; user information; access rights information; and user preference information.

4. A method according to claim 3, wherein user preference information comprises at least one default communication format.

5. A method according to claim 1, further comprising the step of receiving information describing access rights at a management environment via the input device communicating with the management environment over computer network connectivity.

6. A method according to claim 1, further comprising the step of receiving insurance transaction data at a management environment via the input device communicating with the management environment over computer network connectivity.

7. A method according to claim 6, further comprising the step of storing said insurance transaction data in the management environment.

8. A method according to claim 6, further comprising the step of storing said insurance transaction data in at least one database.

9. A method according to claim 1, further comprising the step of receiving insurance transaction documents at the management environment via the input device communicating with the management environment over computer network connectivity.

10. A method according to claim 9, further comprising the step of storing said insurance transaction documents in the management environment.

11. A method according to claim 9, further comprising the step of storing said insurance transaction documents in at least one database.

12. A method according to claim 9, further comprising the step of assigning access rights to a transaction document.

13. A method according to claim 9, further comprising the step of assigning access rights to transaction documents at a page-by-page level.

14. A method according to claim 1, further comprising the step of receiving insurance policy data at the management environment via the input device communicating with the management environment over computer network connectivity.

15. A method according to claim 14, further comprising the step of storing said insurance policy data in the management environment.

16. A method according to claim 14, further comprising the step of storing said insurance policy data in at least one database.

17. A method according to claim 1, further comprising the step of receiving insurance policy documents at the management environment via the input device communicating with the management environment over computer network connectivity.

18. A method according to claim 17, further comprising a step from the group of: storing said insurance policy documents in the management environment; storing said insurance policy documents in at least one database; assigning access rights to a policy document; and
assigning access rights to policy documents at a page-by-page level.

19. A method according to claim 1, further comprising a step from the group of: displaying workload information on the input device communicating with the management environment over computer network connectivity; displaying backlog information on the input device communicating with the management environment over computer network connectivity;
restricting features of the management environment via an access control feature; restricting features of the management environment based at the user level via an access control feature; and restricting features of the management environment based at the organizational level via an access control feature.

20. A method according to claim 19, further comprising the step of restricting features of the management environment based on organizational access rights inherited at the user level.

21. A method according to claim 1, further comprising the step of displaying information related to an insurance transaction on the input device communicating with the management environment over computer network connectivity.

22. A method according to claim 1, further comprising the step of generating queries related to the processing of an insurance transaction.

23. A method according to claim 22, wherein queries are reviewable by interaction with the control module of the management environment in communication with the input device connected via computer network connectivity.

24. A method according to claim 22, wherein queries are electronically delivered to at least one party involved in the insurance transaction settlement process via a messaging module in communication with the input device connected via computer network connectivity.

25. A method according to claim 1, further comprising a step from the group of: responding to queries by interaction with the management environment via the input device connected to the management environment via computer network connectivity; generating notices related to the insurance transaction settlement process; initiating process workflows via the input device communicating with the management environment over computer network connectivity; the management environment, via a control module, guiding the insurance transaction settlement process in accordance with an initiated workflow.

26. A method according to claim 1, further comprising the step of the management environment communicating with at least one market system via a messaging module.

27. A method according to claim 26, wherein said at least one market system is a Bureaux system.

28. A method according to claim 1, further comprising the step of the management environment structuring communication with at least one market system according to at least one industry protocol via a messaging module.

29. A method according to claim 28, wherein said at least one industry protocol comprises at least one of: the Association for Cooperative Operations Research and Development protocol; and London Insurance Market protocol.

30. A method according to claim 1, further comprising the step of the management environment communicating at least one of policy data, claim data, transaction data and transaction documents, policy documents, and claim documents to at least one market system via a messaging module.

31. A method according to claim 30, wherein said at least one market system comprises a Bureaux system.

32. A method according to claim 1, further comprising the step of initiating a transaction via the input device communicating with the management environment over computer network connectivity.

33. A method according to claim 32, further comprising a step from the group of: sending a notification to other interacting parties in communication with the management environment over computer network connectivity that a transaction has been initiated; communicating, via the messaging module, confirmation of the transaction to a user who initiated the transaction;
requesting payment of the transaction via the input device communicating with the management environment over computer network connectivity.

34. A method according to claim 32, further comprising the step of notifying, via the management environment, at least one other party interacting with the management environment that a request for payment has been made.

35. A method according to claim 34, wherein said at least one other party is an insurer of the policy associated with the transaction for which payment was requested.

36. A method according to claim 1, further comprising the step of allocating, via the management environment, assignments among users in the management environment.

37. A system for electronically managing and automating an insurance transaction settlement process, said system comprising:
a management environment configured to store and manage data relevant to insurance transactions; and
an interface device, connected to the management environment over computer network connectivity, configured to transmit information to and receive information from the management environment;
said system adapted, via coordination with the management environment, to reduce the need for an insurance broker in the insurance transaction settlement process.

38. A system according to claim 37, wherein said system is further adapted to do one or more of the following: settle an insurance transaction based at least in part on the information stored in the management environment; control user access to at least one feature of the management environment; store at least one workflow; initiate at least one workflow; generate at least one query; and manage at least one response to a query.

39. A system according to claim 37, wherein said system is further adapted to communicate with at least one market system.

40. A system according to claim 39, wherein said system is further adapted to utilize market standards to structure communications with said at least one market system.

41. A system according to claim 37, wherein said management environment is further configured to guide the insurance claim settlement process according to at least one workflow.

42. A system according to claim 37, wherein the management environment comprises at least one insurance database.

43. A system according to claim 42, wherein said insurance database is configured to store at least one of access rights, workflows, policy data, and transaction data.

44. A system according to claim 34, wherein said management environment comprises at least one documents database.

45. A system according to claim 44, wherein said at least one document database is configured to store at least one of policy documents and transaction documents.

46. A system according to claim 37, wherein said management environment comprises at least one access control database.

47. A system according to claim 46, wherein said access control database is configured to store at least one of organizational control data and user control data.

48. A method according to claim 1, further comprising the step of displaying management information via an input device communicating with the management environment over computer network connectivity.
